(19) United States
(12) Patent Application Publication
(10) Pub. No.: US 2009/0149563 A1
(43) Pub. Date: Jun. 11, 2009

(54) CROSSLINKABLE COMPOSITIONS FOR PAINT PRODUCTS

(76) Inventor: Oscar Della Schiava, Rue Adolphe Diederich (LU)

Correspondence Address: Steinfl & Bruno, 301 N Lake Ave Ste 810, Pasadena, CA, 91101, US

(21) Appl. No.: 12/159,194

(22) PCT Filed: Dec. 30, 2005
(86) PCT No.: PCT/IT2005/000782

§ 371 Date: Sep. 19, 2008

(51) Int. Cl. C08F 2/50; C08J 3/28; C08J 7/04

(52) U.S. Cl. 522/8; 522/153; 522/154; 522/152; 522/39; 522/33; 522/64; 522/75; 427/514

(57) ABSTRACT

The present invention relates to a crosslinkable composition for paint products comprising: a) at least one acrylic oligomer that is crosslinkable through the combined action of heat and UV radiation; b) at least one acrylic oligomer that is crosslinkable through exposure to UV radiation alone; c) at least one acrylic monomer that is crosslinkable through exposure to UV radiation; d) at least one photoinitiator agent; e) at least one additive. The invention also relates to a thermo-crosslinkable paint product added with the aforementioned component, and a process for painting substrates of various natures, preferably car bodies and automotive parts thereof.

The present invention relates to a crosslinkable composition to be used as a component for paint products, to the subsequent composition thus obtained, and to a processing method for substrates of various types.

In particular, the present invention relates to a composition which, once added to a conventional thermo-crosslinkable liquid product, and following exposure to suitable ultraviolet radiation, significantly increases the surface mechanical and chemical properties.

The addition of said composition to a conventional thermo-crosslinkable product does not result in any alterations, from the application and curing standpoint (normally in a conventional dryer), since these are systems which are perfectly compatible in nature, but allows, once the thermal cycle is complete, increased surface performance to the paint product, thus modified, thanks to the simple exposure of the film to a suitable source of ultraviolet radiation.

The need to enhance mechanical and chemical surface properties of the current thermo-crosslinkable paint products, above all in the field of automotive exterior and interior clear coats, is derived from the ever increasing performance demands of the market. Such needs are associated with both increased quality standards, and with the need, in the case of automotive exterior clear coats, to protect the coating from the damage caused by automatic wash systems using various types brushes and detergent products.

Indeed, painted surfaces are subjected to abrasive treatments (brushing, sponging, etc.) along with the use of aggressive chemical detergents, in so-called “car washes”.

These treatments over time leads initially to a loss of surface gloss, with the appearance of more or less widespread areas of hazing. Waxing and polishing etc. only manage to partially repair the above mentioned loss of gloss and aesthetic of the coating. However the deterioration of the surface quality is inevitable and will become evident over time.

Such phenomena can also occur easily with the paint products currently used for automotive interior or for application on other supports (such as plastic, metal, primers, basecoat, etc.), both for top coats (normally clear) and for single layer decorative products. Indeed, in such cases, in addition to poor mechanical resistance, the damage caused by the cleaning of such products with various types of detergents (acidic or basic) is evident.

However, it should be stressed that currently used conventional (or thermo-crosslinkable) paint and coating technology has a wide use (for example in car refinishing and repair) and has the advantage of ease of application, which has lead to very high quality standards (above all aesthetic) for the industrial applications. The raw materials used in the current conventional formulations allow the creation of a wide range of paint products (primers and pigmented base coats, pigmented single layer top coats and clear top coats), all of which, from a application standpoint, are perfectly compatible including multi-layer systems (for example pigmented base coat plus clear top coat). The nature, however, of the raw materials used, limits clearly the formulation leading to restrictions and limitations of the finished properties of the coating, such as for example, hardness and abrasion resistance.

Various types of products have been developed in order to satisfy the increasingly growing demands for surface hardness and resistance.

Starting from acrylic-based raw materials, one of such developments has lead to the creation of acrylic-radical type paint products, or photo-crosslinkable products by means of ultraviolet radiation.

From the polymer standpoint, the raw materials used in a UV radiation crosslinkable coating (or photo-crosslinkable coating), following correct photo-exposure of the polymer film, allow the achievement of particularly remarkable surface mechanical characteristics. Indeed, surface hardnesses and abrasion resistance, several orders of magnitude greater than conventional acrylic based formulations, have been observed. However, such characteristics are also associated with rather high restrictions from the industrial application standpoint. Which, considering also the wide use of painting systems developed specifically for conventional products, are highlighted by a certain lack of flexibility with the purely ultraviolet cross linkable products.

Indeed, the very nature of such products envisages that, once applied, the initiation process (and consequently the propagation thereof) may only occur efficiently if the surface thus painted is uniformly irradiated by suitable ultraviolet radiation. Indeed, the latter must be of a certain wavelength (or, conveniently, consist of a range of wavelengths) of appropriate intensity, and will have to illuminate the polymer film for a certain period of time. Thus, particularly complex geometries such as three-dimensional surfaces are an obstacle to the uniform exposure to UV radiation.

The inability of ultraviolet radiation to uniformly and adequately reach the painted surface leads to the simultaneous presence of areas with optimal crosslinking and others with incomplete crosslinking. An incorrect or non adequate exposure, logical in a product whose crosslinking only occurs following appropriate exposure to a suitable UV source, will result in a imperfectly crosslinked surfaces and hence properties somewhat less than the required standards. Sometime the non-irradiated surfaces appear still wet and tacky.

In terms of formulation, it is possible to prepare various types of photo-crosslinkable systems, however for applications requiring particular surface resistance and hardness the acrylic based products are the best. Once correctly crosslinked, such paint products allow easy management of the items thus treated, which may be handled without the need of further treatments or processes to increase the finished characteristics. If on the other hand this last characteristic constitutes an enormous advantage, from another standpoint it represents a weakness. considering, for example, a UV clear top coat for automotive exterior applications, the procedure to mechanically remove any surface impurities trapped in the liquid film prior to crosslinking and definitively encapsulated following the exposure to ultraviolet radiation, would be particularly difficult. Vice versa, in a conventional thermo-crosslinkable product, the hardness after crosslinking is lower compared to photo-crosslinkable products, any impurities trapped within the film are easily removed mechanically, allowing the so-called “refinish or repair” of the car body prior to complete crosslinking after at least 24 hours at room temperature.

Considering the limits, listed above, for both technologies (thermo-crosslinkable and photo-crosslinkable), a number of examples tending towards their convergence, from a formulation standpoint, have emerged in recent years. So-called “dual cure” compositions are already on the market and are patent protected, the formulation however is based on acrylic products with primary functionality and use in the ultraviolet field. Such products, modified at structural level, have both a thermal and photo-crosslinkable nature. This dual functionality is expressed by the simultaneous presence of hydroxyl terminating functional groups (—OH) and olefin double bonds (C═C) in acrylic monomers and oligomers. The former allow the formation of molecular bonds through a NCO/OH condensation reaction (polyisocyanates and hydroxyl groups); while the latter, once the free radical formation reaction has been started by photoinitiators, crosslink by exposure to UV radiation. The outcome of such a concomitant UV radiation/heat action leads to the final crosslinking of the paint film. Depending on the situation, in such compositions the application stage may be followed by exposure to ultraviolet radiation, in which shadow areas however, in practice those which have not been adequately irradiated by the latter, may have their crosslinking (or total curing) brought to completion through exposure to a suitable source of heat (or IR radiation). In other cases, the application stage may be followed by an oven curing stage, or exposure to an IR source (curing specs may vary depending on the nature of the product), and subsequent exposure to ultraviolet radiation. Certain compositions require, following exposure to UV radiation, NIR radiation (Near Infra Red—with a wavelength comprised of between 760 and 1500 nm) to crosslink hidden and non-exposed areas.

The type of compositions described above allow to overcome situations where correct exposure of the applied coating to ultraviolet radiation, combined with the achievement of excellent mechanical and chemical surface properties (obviously after the final thermo-crosslinking process) is not possible.

The spread of such UV products with final “post-curing” using heat or IR radiation, has however encountered some significant difficulties at application process level. To make an example we might consider the application of a conventional thermo-crosslinkable product, such as a clear top coat for car body application. The various process steps consider the painting of the item (normally by spraying) and the subsequent oven curing of the product (normally using static, auto ventilating ovens). Such system, widely used both at OEM and at car repair level, is particularly simple. Use of a UV clear top coat would require, after the application step, a UV curing system involving a lamp emitting ultraviolet light and an oven for the thermal post-curing of the product (although the thermal curing cycle will have reduced temperatures and times compared to conventional products). From the coating line standpoint, existing lines would require major modifications, since, in order to achieve the required final properties, the product will require almost complete exposure to the UV lamp, exposure which will have to be carried out in-line. In other words, in the case of the use of “dual cure” compositions, the UV lamps will have to be mounted before or after the thermal (or IR) curing oven, but in any case, in-line with the coating line. However UV treatment may not be done off-line, because the product, after the thermal crosslinking step, may not be handled without the risk of damaging the coated surface.

Following the considerations made so far, the solution of combining the two technologies (conventional and ultraviolet), by modifying a UV crosslinkable product with a dual nature resin, conflicts with the requirement of significant line modification, new equipment investments and radical changes in the practical use of the products.

For the above mentioned reasons, the “dual cure” compositions currently available are not widely used.

The problem addressed by the present invention is to convert a conventional thermo-crosslinkable paint into a thermo/photo-crosslinkable paint, where the UV treatment, even though optimal final properties would be delivered to the coating, may also be omitted. Without, in no way, losing the characteristics of the standard conventional thermo-crosslinkable coating. In this way, the paint, after or in-line with the thermal curing oven, and eventually subjected to potential refinish and/or final polishing, may be subsequently, if desired, treated by UV to obtain the superior surface finishing qualities and properties.

The above described problems are solved by a component for paint products, by a paint composition containing said component and by a method for painting substrates as defined in the enclosed claims.

Hence, the initial aspect of the present invention relates to a thermo/photo-crosslinkable component comprising:
a) at least one acrylic oligomer that is crosslinkable through the combined action of heat and UV radiation;
b) at least one acrylic oligomer that is crosslinkable through exposure to UV radiation alone;
c) at least one multifunctional acrylic monomer that is crosslinkable through exposure to UV radiation;
d) at least one photoinitiator agent;
e) at least one additive.

The composition of the present invention is added to a conventional thermo-crosslinkable resin thus giving a paint product having surprising hardness and resistance, as explained hereinafter in further details.

The acrylic oligomer that is crosslinkable through the combined action of heat and UV radiation is an acrylic acrylate oligomeric resin advantageously diluted to 45% in a butyl acetate diluent and having a viscosity advantageously comprised of between 2800 and 3200 mPa·s, at 25° C. A commercial example of such an oligomer is EBECRYL® 1200 from CYTEC.

In formulations, this resin is comprised of between 50 and 70% by weight, and is preferably used in percentages comprised of between 58 and 62% by weight.

It is included in formulations because it has terminal hydroxyl groups capable, in the presence of suitable photoiniator, to react, through the action of heat, with conventional thermo-crosslinkable resins. Indeed, such resin possesses terminal —OH (hydroxyl) groups that are crosslinkable through the action of polyisocyanates (present in the conventional crosslinkable resin) and unsaturated double bonds (C═C) that are crosslinkable through UV treatment. Furthermore, it confers the thermo-crosslinkable resin, to which it has been added, excellent hardness, flexibility and excellent resistance to chemical agents.

The acrylic oligomer that is crosslinkable through exposure to UV radiation alone is an aliphatic urethane acrylate oligomer resin, preferably having a molecular weight comprised of between 700 and 1500, more preferably between 900 and 1100, and having a viscosity advantageously comprised of between 1800 and 2200 mPa·s, at 60° C. It has furthermore been observed that the urethane functionality of this oligomer may be equal to one or higher, even if the preferred functionality is equal to 6.

A commercial example of the oligomer described is EBECRYL® 1290 from CYTEC, or alternatively Bencryl 655 from Benasedo SpA is used.

In formulations, this compound may be comprised of between 5 and 20% by weight; it is preferably used in percentages comprised of between 10 and 15% by weight.

Said oligomer confers the coating with the desired hardness, high solvent resistance and durability to external agents (exterior durability).

The acrylic monomer that is crosslinkable through exposure to UV radiation, is a multifunctional acrylate monomer advantageously having a molecular weight comprised of between 300 and 700, preferably between 400 and 600, and having a viscosity advantageously comprised of between 15500 and 16500 mPa·s, at 25° C. It has furthermore been observed that the acrylic functionality of this oligomer may be equal to one or higher, even if the preferred functionality varies between five and six.

A commercial example of the monomer described may be DPHA (dipentaerythritol penta/hexa acrylate) from CYTEC.

In formulations, this compound may comprise between 5 and 20% by weight; it is preferably used in percentages comprised of between 10 and 15% by weight. It is included in formulations in order to confer the coating with high reactivity, increased crosslinking density, increased resistance to scratches and abrasion, excellent hardness and good chemical resistance.

The photoinitiator agent of the thermo/photo-crosslinkable component of the invention performs an essential role in order to obtain rapid and efficient crosslinking of the composition components, once exposed to suitable ultraviolet radiation.

Suitable photoinitiators include compounds that are photosensitive to UV radiation as sources of free radicals, such as for example: hydroxyketones, aminoketones and ketosulphones, benzyldimethylketals, benzophenones, acylphosphines and thioxanthones.

It has furthermore been observed that the presence of several photoinitiators in the thermo/photo-crosslinkable composition formulation, besides increasing the polymerisation rate of the acrylic based polymer mixture, determines a balance in the degree of curing of the paint, both at the surface as well as throughout the coating film.

In a preferred formulation, a combination of two photoinitiators, conveniently constituted by two alphahydroxyketones or by one alphahydroxyketone and one phenylglyoxylate is used.

For example, a combination of particularly suitable photoinitiators is constituted by a mixture of one alphahydroxyketone such as IRGACURE® 184 from Ciba Speciality Chemicals, conveniently present in quantities comprised of between 4 and 7% by weight, preferably between 5.2 and 5.8% by weight, and one alphahydroxyketone such as DAROCUR® 2959 from Ciba Speciality Chemicals, conveniently present in quantities comprised of between 4 and 7% by weight, preferably between 5.2 and 5.8% by weight. Another example of a combination of particularly suitable photoinitiators is constituted by a mixture of one phenylglyoxymate such as IRGACURE® 754 from Ciba Speciality Chemicals, conveniently present in quantities comprised of between 4 and 7% by weight, preferably between 5.2 and 5.8% by weight, and one alphahydroxyketone such as DAROCUR® 2959 from Ciba Speciality Chemicals, conveniently present in quantities comprised of between 4 and 7% by weight, preferably between 5.2 and 5.8% by weight.

Typically the photoinitiators are present as a mixture in the component, covered by this invention, in quantities varying between 8 and 13% by weight.

The component, covered by this invention, also comprises one or more additives to improve stability to atmospheric agents (for example humidity, pollutants, oxygen, ultraviolet light etc.), above all in the case of addition to paint products for exterior use. Indeed, the polymeric structure of the latter, due to the results of absorption of ultraviolet light (such as sunlight) and atmospheric impurities, might undergo a photo oxidative degradation. A mixture of additives capable of preventing any photo oxidative damage is conveniently constituted by a combination of UV radiation (sunlight) filters and by inhibitors of any free radicals potentially formed.

Suitable ultraviolet radiation filters (or UVAs—UVadsorbers) include the hydroxyphenyl-triazines (HPT). While a good family of free radical inhibitors includes the so-called HALS (Hindered Amine Light Stabilisers).

It has furthermore been observed that the combination of the two families, HPT and HALS, in the formulation of the component, besides protecting against potential colour changes in the final coating, offer optimal prevention with respect to loss of gloss.

One particularly suitable mixture of the two above-mentioned compounds has been the combination of a hydroxyphenyltriazine such as TINUVIN® 400 from Ciba Speciality Chemicals, conveniently present in quantities ranging between 0.5 and 1.5% by weight, preferably between 0.7 and 1.1% by weight, and a Hindered Amine Light Stabilizer such as TINUVIN® 123 from Ciba Speciality Chemicals, conveniently present in quantities ranging between 0.3 and 1.2% by weight, preferably between 0.5 and 0.9% by weight.

Typically, in the component covered by this invention, the additives are present as a mixture in quantities varying between 1.0% and 2.0% by weight.

The thermo/photo-crosslinkable component covered by this invention is added to a conventional thermally crosslinked paint product. As already explained, the thermally crosslinked paint products, despite being widely used throughout the industry, lack in hardness and abrasion resistance. The present invention deals with and solves this problem from a different standpoint compared to current knowledge and state of the art.

Indeed, “dual-cure” formulations are compositions obtained through the chemical modification of thermo-crosslinkable products, to give molecules with dual functionality, the capability of being crosslinked through the actions of both UV and heat.

This implies that for the application of “dual-cure” products, it is necessary to modify the painting systems, with significant costs for the companies involved in this industry. Instead, the present invention, by providing a thermo/photo-crosslinkable component to be added to conventional thermo-crosslinkable products, allows significant improvements in the final properties of the coating avoiding, at the same time, modifications of the coating lines.

This is possible, because the present invention provides a thermo/photo-crosslinkable component comprising an acrylic oligomer having functionality which crosslinks as a result of thermal action, i.e. terminal hydroxyl groups which react with the isocyanates of the conventional thermo-crosslinkable paint product through the action of heat, and functionality which crosslinks through the action of ultraviolet radiation, i.e. double bonds. The application of UV radiation causes the other components of the component, i.e. the acrylic oligomer and acrylic monomer possessing UV-mediated crosslinkable functionality alone, i.e. double bonds, to react by means of free radicals, with the double bonds already introduced into the conventional thermo-crosslinkable resin through condensation reaction with the dual functionality resin of the component. Thus, the thermo/photo-crosslinkable acrylic resin of the component acts as a linker between the conventional thermo-crosslinkable resin, on one side, and the photo-crosslinkable components of the additive. The conversion of the conventional paint into a thermo/photo-crosslinkable paint is thus obtained.

In this way, without modification of the basic chemical composition of the paint products, and using conventional painting facilities, a final coating is obtained which has excellent hardness, gloss and abrasion resistance properties.

In particular, the conventional thermo-crosslinkable paint, with the addition of the component covered by the invention, after thermal treatment already reaches properties entirely similar to those of the paint without the addition the component. At this point, as usual, the car body will leave the coating line and if needed will go through refinish. only at this point, if desired, the car body will be treated by UV radiation and hence reaching those optimal finishing properties which only photo-crosslinkable paints can achieve. The UV treatment may be performed off-line.

The conventional paint products suitable to be modified with the addition of the thermo/photo-crosslinkable composition covered by the invention include filler primers, pigmented and clear primers, clear top coats and pigmented single layer top coats, preferably used for painting car bodies but also automotive parts both interior and exterior, but also for painting substrates of various kinds and nature, and not necessarily used for automotive. Preferably, such products are acrylic in nature, even if it is also possible to obtain such a property increase also with polyurethane-based systems, wherein, in order to avoid any potential chemical incompatibility, the percentages of the component are lower compared to acrylic based systems.

The percentage of the component to be added to the conventional paint product varies proportionally based on the final properties required, in terms of mechanical surface resistance. Addition percentages conveniently comprised of between 5% and 35% by weight, preferably between 15% and 25% of the total formulation, lead to significant increases in the above-mentioned resistances.

Addition of the thermo/photo-crosslinkable composition to the final paint system (in the liquid stage) does not result in any significant variations in the application parameters of the latter, whether carried out by immersion, spray or flow coating etc.

The conventional thermo-crosslinkable paint products are normally obtained by mixing an acrylic resin having hydroxyl functionalities (mixture A) with an acrylic resin with isocyanate functionalities (mixture B). These two resins must be handled separately since, otherwise, they would begin to react, even at room temperature.

Hence the end user must take care of their mixing, prior to application onto the substrate, at this point adding the component covered by the invention. Alternatively, the component of the invention may be pre-mixed in mixture A, which will then be added to mixture B.

A further way to implement the invention might be a product where the component already contains mixture A. In this way, a paint kit may be provided, comprising the component of the invention together with the hydroxyl component of the conventional paint product (mixture A) and, separately, the isocyanate component of the conventional paint (mixture B).

In accordance with another aspect of the present invention, a process is provided for painting a substrate comprising the following steps:
a) Adding the component of the invention to a conventional thermo-crosslinkable paint product;
b) applying the mixture obtained in a) to any kind of substrate;
c) curing the painted substrate according to the specifications of the thermo-crosslinkable paint product;
d) eventually, in case it is required to increase the mechanical surface properties, crosslink by means of irradiation with ultraviolet light produced by UV lamps.

In step a) alternatively the thermo/photo-crosslinkable component of the invention could be added to one of the two mixtures making up the conventional thermo-crosslinkable resins. In particular, to the mixture comprising the resin having hydroxyl functionality. In this case, it will be sufficient to mix the combined mixture A with mixture B (comprising a resin having isocyanate functionality) in order to obtain the final product to be used in step b).

In step b) by substrate is preferably meant a car body or automotive parts exterior and/or interior. For example, for exterior car body application, the mixture of step b) is applied over a coloured base, while for interior parts, it may be applied onto plastic parts as a single coat.

Advantageously, curing, step c) occurs in an oven, according to the conventional non-added products and process cycle, and leads to surface crosslinking also of the modified product with component covered by this invention. The hardness of such surface will be equal to that of a conventional (non-added) product, but once the surface will be exposed to ultraviolet radiation, it will reach the excellent mechanical surface properties described in the invention. Advantageously, any impurities (dust spots etc.) will be mechanically removed from the painted surface, prior to be exposed to ultraviolet radiation.

Advantageously, mercury vapour arc lamps and electrodeless microwave lamps are used for crosslinking. The UV crosslinking technology uses a radiation emission source, with emission spectrum comprised of between 200 and 450 nm. The energy required for complete crosslinking of the exposed area (also known as DOSE, and measured in J/cm²) is comprised of between 2 and 8 J/cm², preferably between 4 and 6 J/cm², in the UVA band emission range of the ultraviolet spectrum (UV-A spectral region: between 320 and 390 nm; UV-B spectral region: between 280 and 320 nm; UV-C spectral region: between 250 and 260 nm; UV-Vis spectral region: between 395 and 445 nm).

The UV lamps used for crosslinking in step d) may be located in the coating line, or off the coating line.

The process according to the invention allows to produce a coating which increases mechanical surface resistance, specifically indicated for use in the conventional and existing paint system and processes.

The following examples are given by way of pure illustration of the present invention, and hence must not be interpreted as any form of limitation of the scope of protection, which is defined by the enclosed claims.

A. Examples of formulation of the thermo/photo-crosslinkable component to be incorporated into a conventional paint system in order to enhance the hardness and surface resistance properties.

### EXAMPLE 1

| | % by |
|---|---|
| Thermo/photo crosslinkable additive components | weight |
| Acrylic acrylate oligomer (45% in BAC) | 62.0 |
| Aliphatic hexafunctional urethane acrylate oligomer - | 12.5 |
| MW 1000 | |
| Multifunctional acrylate monomer - MW 500 | 12.5 |
| Photoinitiator (alphahydroxyketone) | 5.7 |
| Photoinitiator (alphahydroxyketone) | 5.7 |
| Additive 1 (Hindered Amine Light Stabilizer) | 0.7 |
| Additive 2 (hydroxyphenyltriazine) | 0.9 |

BAC = butyl acetate

### EXAMPLE 2

| Thermo/photo crosslinkable additive components | % |
|---|---|
| Acrylic acrylate oligomer (45% in BAC) | 62.0 |
| Aliphatic hexafunctional urethane acrylate oligomer - | 12.5 |
| MW 1000 | |
| Multifunctional acrylate monomer - MW 500 | 12.5 |
| Photoinitiator (Phenylglyoxylate) | 5.7 |
| Photoinitiator (alphahydroxyketone) | 5.7 |
| Additive 1 (Hindered Amine Light Stabilizer) | 0.7 |
| Additive 2 (hydroxyphenyltriazine) | 0.9 |

B. Percentage and method of incorporation of the thermo/photo-crosslinkable component into a conventional paint system.

In accordance with the previously highlighted points of incorporating the thermo/photo-crosslinkable component into a conventional formulation in a very simple and easy way, said process will be implemented by simply mixing the liquid components in the pre-application preparation stage of the conventional product.

Examples of a formulation pertaining to a conventional clear top coat from PPG® (DELTRON® High Solid Series) as it is, and the same product added with the component of the present invention, are reported hereinafter by way of explanation.

TABLE 1

| | | SUPPLEMENTED |
|---|---|---|
| | CONVENTIONAL | FORMULATION |
| | FORMULATION | (% IN PARTS) |
| | (% IN PARTS) | SUPPLEMENTED |
| COMPONENTS | DELTRON ® | DELTRON ® |
| DELTRON ® 880 (BASE | 100 | 65 |
| RESIN) | | |
| THERMO/PHOTO- | / | 35 |
| CROSSLINKABLE | | |
| COMPONENT | | |
| DELTRON ® 841 | 50 | 50 |
| (CATALYST) | | |
| DELTRON ® 807 | 35 | 35 |
| (SOLVENT) | | |

c. Comparison between the conventional and the added system.

Based on the percentages of the component listed in Table 1, the data obtained from comparing the conventional formulation, with and without component, are reported hereafter. The application cycle has been the same for both formulations (spray application on coated metal sheets with a black PPG® basecoat). Furthermore, such formulations have been treated with the same oven “curing” conditions (according to the PPG data sheet). In consideration of the present invention, the added clear top coat has subsequently been exposed to ultraviolet radiation.

The comparison method used in the present work foresees the adoption of abrasion tests or Taber Tests according to ASTM standard D4060 (weight loss).

Indications on the Taber Abrasion Test.

ASTM D1044 (haze), D3389, D4060 (weight loss).

The Taber abrasion test is a test which determines plastic resistance to abrasion. Abrasion resistance is defined as a material's capacity to oppose mechanical action such as friction, scraping and erosion. It may be difficult to determine abrasion, hence, variation in the degree of hazing and weight loss are frequently evaluated.

Test procedure: the level of hazing, or the original weight of the sample under test, is measured. The sample is then placed on the abrasion tester. A 250, 500 or 1000 gram load is then placed on the abrader wheel, which is then left to rotate for a certain number of revolutions. Various abrasion wheels are used and the degree of hazing or the final weight are measured. The load and the wheel may be adjusted for softer or harder materials.

Sample dimensions: a four inch diameter disk or a four inch square plate is used. A central hole with a diameter of four inches is necessary.

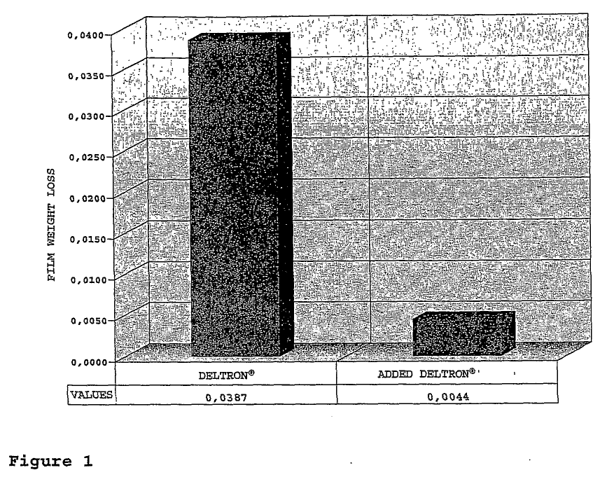

FIG. 1 shows the results, expressed as percentage weight loss per thousand abrasion cycles. From the graph, it may be deduced that the non-added conventional product (indicated simply as DELTRON®) has a weight loss equal to 0.0387 mg. The same conventional product with the addition (indicated now as ADDED DELTRON®), based on the percentages given in TABLE 1, with the thermo/photo crosslinkable component, and exposed, after the oven curing cycle (according to the PPG data sheet), to a suitable ultraviolet radiation source, shows a weight loss following abrasive action equal to 0.0044 mg. Direct comparison of the data highlights an eight orders of magnitude increase in mechanical surface properties, following the addition of the component of the present invention.

1. A component for thermo-crosslinkable paint products, the component comprising:
a) at least one acrylic oligomer crosslinkable through the combined action of heat and UV radiation;
b) at least one acrylic oligomer crosslinkable through exposure to UV radiation alone;
c) at least one acrylic monomer that crosslinkable through exposure to UV radiation;
d) at least one photoinitiator agent; and
e) at least one additive.

2. The component according to claim 1, wherein said acrylic resin, crosslinkable through the combined action of heat and UV radiation, is an acrylic acrylate oligomeric resin.

3. The component according to claim 2, wherein said acrylic acrylate oligomeric resin is diluted to 45% in a diluent, the diluent being butyl acetate (BAC).

4. The component according to claim 2, wherein said acrylic acrylate oligomeric resin possesses terminal hydroxyl (—OH) groups that are thermo-crosslinkable with polyisocyanates and photo-crosslinkable double bonds.

5. The component according to claim 2, wherein said acrylic acrylate oligomeric resin has a viscosity comprised of between 2800 and 3200 mPa·s at 25° C.

6. The component according to claim 2, wherein said acrylic acrylate oligomeric resin is EBECRYL 1200 from CYTEC.

7. The component according to claim 2, wherein said acrylic acrylate oligomeric resin is present in mixtures in quantities ranging from 50 to 70% by weight.

8. The component according to claim 1, wherein said acrylic oligomer crosslinkable through exposure to UV radiation alone, is an aliphatic urethane acrylate oligomeric resin.

9. The component according to claim 8, wherein said aliphatic urethane acrylate oligomeric resin has a molecular weight comprised of between 700 and 1500.

10. The component according to claim 8 or 9, wherein said aliphatic urethane acrylate oligomeric resin has a viscosity comprised of between 1800 and 2200 mPa·s at 60° C.

11. The component according to claim 8, wherein said aliphatic urethane acrylate oligomeric resin has at least one urethane functionality.

12. The component according to claim 8, wherein said aliphatic urethane acrylate oligomeric resin is EBECRYL 1290 from CYTEC or BENCRYL 655 from Benasedo SpA.

13. The component according to claim 8, wherein said aliphatic urethane acrylate oligomeric resin is present in mixtures in quantities ranging between 5 and 20% by weight.

14. The component according to claim 1, wherein said acrylic monomer, crosslinkable through exposure to UV radiation is a multifunctional acrylate monomer.

15. The component according to claim 14, wherein said multifunctional acrylate monomer has a molecular weight comprised of between 300 and 700.

16. The component according to claim 14, wherein said multifunctional acrylate monomer has a viscosity comprised of between 15500 and 16500 mPa.β at 25° C.

17. The component according to claim 14, wherein said multifunctional acrylate monomer has a degree of multifunctionality varying between five and six olefin double bonds.

18. The component according to claim 14, wherein said multifunctional acrylate monomer is DPHA (dipentaerythritol penta/hexa acrylate) from CYTEC.

19. The component according to claim 14, wherein said multifunctional acrylate monomer is comprised in a mixture in quantities ranging from 5 to 20% by weight.

20. The component according to claim 1, wherein said at least one photoinitiator agent is selected from hydroxyketones, aminoketones and ketosulphones, benzyldimethylketals, benzophenones, acylphosphines, thioxanthones and mixtures thereof.

21. The component according to claim 20, wherein said at least one photoinitiator agent is a mixture selected from: a mixture of two different alphahydroxyketones or a mixture of an alphahydroxyketone and a phenylglyoxylate.

22. The component according to claim 21, wherein said mixture of two alphahydroxyketones comprises IRGACURE 184 and DAROCUR 2959 from Ciba Speciality Chemicals, and said mixture of an alphahydroxyketone and a phenylglyoxylate comprises DAROCUR 2959 and IRGACURE 754, respectively, from Ciba Speciality Chemicals.

23. The component according to claim 20 wherein said at least one photoinitiator agent is present in a mixture in quantities comprised of between 8 and 13% by weight.

24. The component according to claim 1, comprising one or more additives for preventing potential photo-oxidative damage, said one or more additives selected from an ultraviolet radiation filter and a free radical inhibitor.

25. The component according to claim 24, wherein said ultraviolet radiation filter is a hydroxyphenyltriazine (HPT) and said free radical inhibitor is a Hindered Amine Light Stabilizer (HALS).

26. The component according to claim 24, wherein said one or more additives is a mixture of a hydroxyphenyltriazine and a HALS.

27. The component according to claim 26, wherein said mixture of hydroxyphenyltriazine and a HALS mixture is present in quantities comprised of between 1.0% and 2.0% by weight.

28. A photo/thermo-crosslinkable composition comprising the component according to claim 1, and a conventional thermo-crosslinkable paint product, the conventional thermo-crosslinkable paint product selected from: filler primers, pigmented and clear primers, clear top coats and pigmented single layer top coats.

29. The composition according to claim 28, wherein said component is present in quantities ranging from 5 to 35% by weight.

30. The composition according to claim 28, wherein said conventional thermo-crosslinkable paint product is obtained by mixing a mixture A with a mixture B, the mixture A comprising an acrylic resin with hydroxyl functional groups, and the mixture B comprising an acrylic resin with isocyanate functional groups.

31. A paint kit comprising: the component according to claim 1, a mixture A and comprising an acrylic resin with hydroxyl functional groups a mixture B comprising an acrylic resin with isocyanate functional groups.

32. A process for painting a substrate, the process comprising the following steps:
a) adding the component according to claim 1, to a thermo-crosslinkable paint product thus obtaining a mixture;
b) applying the mixture obtained in a) to a substrate thus obtaining a painted substrate;
c) curing the painted substrate according the specifications of the thermo-crosslinkable paint product thus obtaining a cured painted product.

33. The process according to claim 32, further comprising a step d) of irradiating the cured painted product obtained in step c) with ultraviolet light.

34. The process according to claim 33, wherein the irradiation with UV light is carried out through use of a UV lamp along a coating line, the UV lamp positioned in the coating line or off the coating line.

35. The process according to claim 32, wherein the thermocrosslinkable paint product of step a) is obtained by mixing a mixture A comprising an acrylic resin with hydroxyl functional groups with a mixture B comprising an acrylic resin with isocyanate functional groups.

36. The process according to claim 32, wherein the substrate of step b) is a car body or an automotive exterior or interior part.

37. The process according to claim 32, further comprising the step of c1) mechanically removing surface impurities from the cured painted product obtained in step c).

38. The process according to claim 32, wherein curing the painted substrate of step c) is performed in a oven according to the conventional paint product specifications.

39. The process according to claim 33, wherein mercury vapour arc lamps or electrodeless microwave lamps are used for UV crosslinking.

40. The process according to claim 33, wherein a radiation source emitting wavelengths comprised of between 200 and 450 nm is used for the UV crosslinking.

41. The process according to claim 33, wherein the energy necessary for complete crosslinking of the cured painted product is between 2 and 8 j/cm², in the UVA band emission range of the ultraviolet spectrum.

42. The component according to claim 2, wherein said acrylic acrylate oligomeric resin is present in mixtures in quantities ranging from 58 to 62% by weight.

43. The component according to claim 8, wherein said urethane acrylate oligomeric resin has a molecular weight of between 900 and 1100.

44. The component according to claim 8, wherein said urethane acrylate oligomeric resin has six urethane functionalities.

45. The component according to claim 8, wherein said urethane acrylate oligomeric resin is present in mixtures in quantities ranging between 10 and 15% by weight.

46. The component according to claim 14, wherein said multifunctional acrylate monomer has a molecular weight of between 400 and 600.

47. The component according to claim 14, wherein said multifunctional acrylate monomer is comprised in a mixture in quantities ranging from 10 to 15% by weight.

48. The component according to claim 26, wherein said hydroxyphenyltriazine is TINUVIN 400 and said HALS is TINUVIN 123 from Ciba Speciality Chemicals.

49. A photo/thermo-crosslinkable composition according to claim 28, wherein the conventional thermo-crosslinkable paint product is acrylic in nature.

50. The composition according to claim 28, wherein said component is present in quantities ranging from 15 to 25% by weight.

51. The process according to claim 33, wherein the energy necessary for complete crosslinking of the exposed area is between 4 and 6 j/cm².
